(19) United States
(12) Patent Application Publication
(10) Pub. No.: US 2026/0177320 A1
(43) Pub. Date: Jun. 25, 2026

(54) APPARATUS FOR REMOVING DUST EMITTED FROM MELTING FURNACE

(71) Applicant: KOREA HYDRO & NUCLEAR POWER CO., LTD, Gyeongju-si (KR)

(72) Inventors: Seok Ju HWANG, Daejeon (KR); Young Hwan HWANG, Daejeon (KR); Mi Hyun LEE, Daejeon (KR); Cheon Woo KIM, Daejeon (KR)

(21) Appl. No.: 18/716,305

(22) PCT Filed: Feb. 1, 2024
(86) PCT No.: PCT/KR2024/001559

§ 371 Date: Jun. 4, 2024

(30) Foreign Application Priority Data
Mar. 2, 2023 (KR) 10-2023-0027449

(51) Int. Cl. F27D 17/22; B01D 46/00; B01D 46/10; B01D 46/681; B01D 46/71; B01D 46/74; F23J 15/02

(52) U.S. Cl. CPC F27D 17/22; B01D 46/0086; B01D 46/10; B01D 46/681; B01D 46/71; B01D 46/74; F23J 15/025; B01D 2273/20

(57) ABSTRACT

The disclosure relates to an apparatus for removing dust emitted from a melting furnace, the apparatus an exhaust unit that discharges dust and moisture from a melting space of the melting furnace to an outside; a filter that is located inside the exhaust unit, and arranged to have one side facing the melting space; and a dust removal unit that improves the filter in dust removal capability.

### TECHNICAL FIELD

The disclosure relates to an apparatus for removing dust emitted from a melting furnace.

### BACKGROUND ART

As in general (solid and liquid) waste incinerator or/and melting furnace facilities, when hazardous waste is treated by incineration·melting (glass solidification treatment, etc.), generated exhaust gas contains unburned carbon, ash, heavy metal particles, and the like solid and liquid particles.

To treat such particles (dust), the particles are first collected as separated from gaseous substances in the exhaust gas. As secondary waste, dust (settled ash and scattering ash) generated in this case needs to undergo separate treatment. In particular, dust generated when treating radioactive waste contains radioactivity, and thus special care is required when treating such dust.

Further, due to dust generated when solid waste is input and a large amount of moisture generated when liquid waste is input, a phenomenon that dust accumulates inside a pipe cooler occurs.

Such a dust accumulation phenomenon not only causes difficulty in handling due to the scattering of dust, increase in costs for dust treatment, and increase in the complexity of related apparatuses, but also causes a problem of consequentially decreasing the utilization rate of the melting furnace.

### DISCLOSURE

### Technical Problem

An aspect of the disclosure is to provide an apparatus for removing dust emitted from a melting furnace.

### Technical Solution

According to an embodiment of the disclosure, an apparatus for removing dust emitted from a melting furnace includes: an exhaust unit that discharges dust and moisture from a melting space of the melting furnace to an outside; a filter that is located inside the exhaust unit, and arranged to have one side facing the melting space; and a dust removal unit that improves the filter in dust removal capability.

The exhaust unit may include: an exhaust port communicating with the melting space; a first pipe connected to the exhaust port in a first direction; a second pipe connected to and bent from the first pipe; a connection unit connecting the first pipe and the second pipe; and a moisture cooler cooling the moisture discharged through the second pipe.

The exhaust unit may include: a pressure gauge measuring each internal pressure of the first pipe and the second pipe; and a stopper for preventing the filter from separation, the first direction may be a vertical direction, and the second pipe may extend in a horizontal direction.

The filter may be shaped like a plate and diagonally located in the connection unit, the filter may be at least one of a mesh type and a perforated type, and the dust may be desorbed from the filter through the dust removal unit and the desorbed dust may be resupplied to the melting space.

The dust removal unit may include: a driving unit applying physical force to the filter to desorb accumulated dust; and a driving control unit controlling operations of the driving unit based on a measured value of the pressure gauge, and the driving control unit may control the driving unit to operate only when a pressure difference between the first pipe and the second pipe is above a certain level.

The driving unit may operate to move a portion of the filter up and down.

The driving unit may include a propeller that applies air flow to the filter.

The driving unit may include a hammer that applies physical impact to the filter.

The driving unit may include a sliding member that slides along a surface being in contact with the filter.

### Advantageous Effects

According to the disclosure, there is provided an apparatus for removing dust emitted from a melting furnace.

### DESCRIPTION OF DRAWINGS

FIG. 1 illustrates a melting apparatus according to a first embodiment of the disclosure,

FIG. 2 is an enlarged view of “A” in FIG. 1,

FIGS. 3A and 3B illustrate a filter in the melting apparatus according to the first embodiment of the disclosure,

FIG. 4 illustrates a driving unit according to the first embodiment of the disclosure,

FIG. 5 illustrates a driving unit according to a second embodiment of the disclosure,

FIG. 6 illustrates a shape in a direction “B” in FIG. 5,

FIG. 7 illustrates a driving unit according to a third embodiment of the disclosure,

FIG. 8 illustrates a driving unit according to a fourth embodiment of the disclosure, and

FIG. 9 illustrates a shape in a direction “C” in FIG. 8.

### MODE FOR INVENTION

Below, the disclosure will be described in more detail with reference to the accompanying drawings.

The accompanying drawings are merely an example illustrated to describe the technical concept of the disclosure in more detail, and thus the technical concept of the disclosure is not limited to the accompanying drawings. Further, the size and spacing of elements in the accompanying drawings may be exaggerated compared to reality so as to describe relationships between the elements.

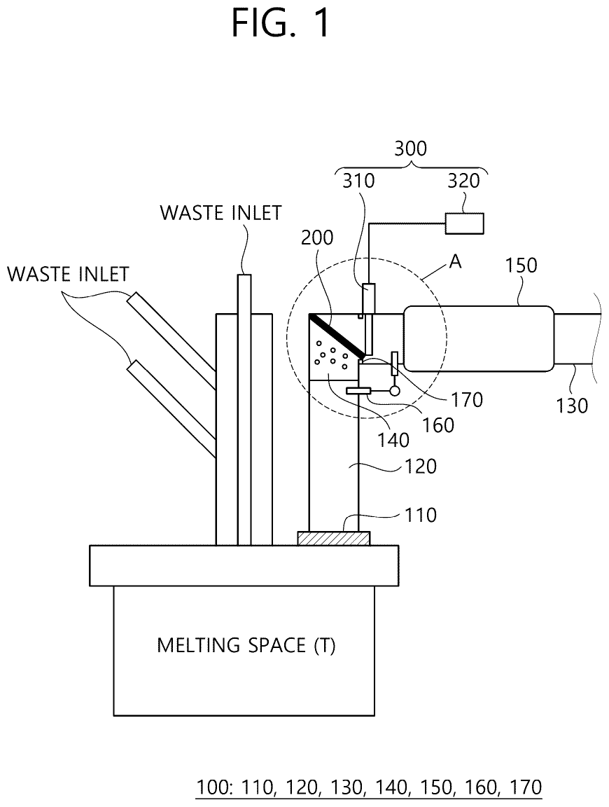

An apparatus for removing dust emitted from a melting furnace according to a first embodiment of the disclosure (hereinafter referred to as a ‘dust removal apparatus’) will be described with reference to FIGS. 1 to 4.

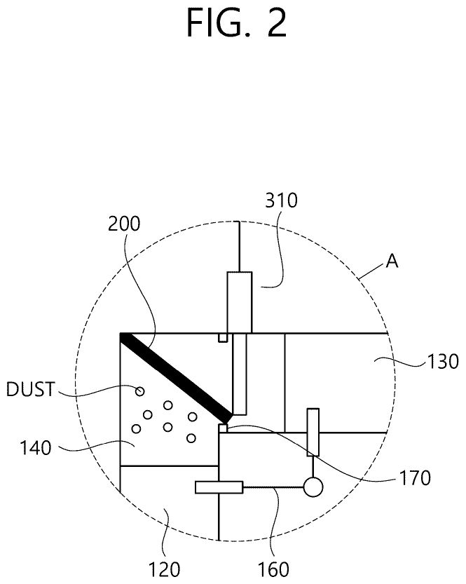

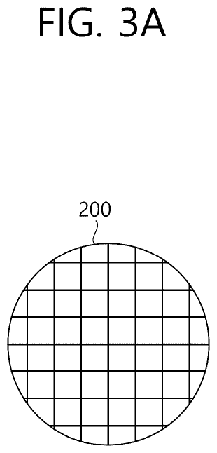

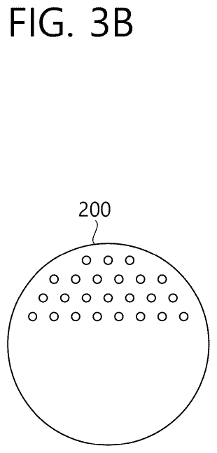

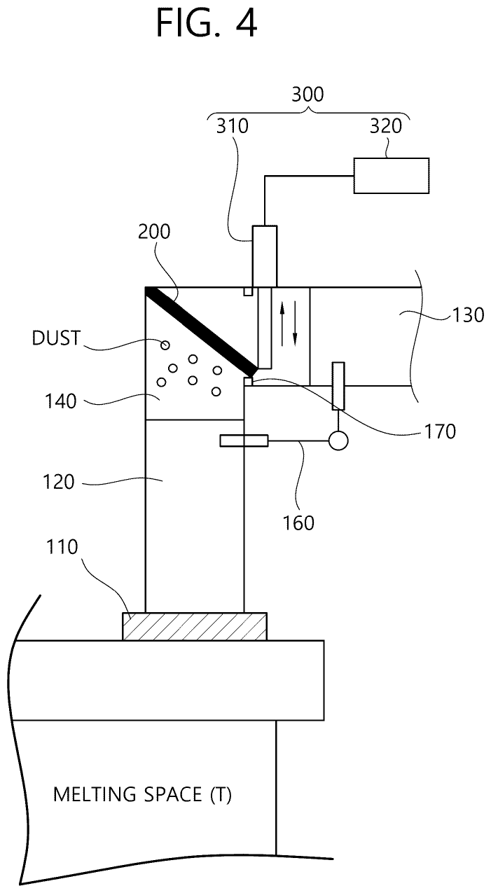

FIG. 1 illustrates a melting apparatus according to a first embodiment of the disclosure, FIG. 2 is an enlarged view of “A” in FIG. 1, FIGS. 3A and 3B illustrate a filter in the melting apparatus according to the first embodiment of the disclosure, and FIG. 4 illustrates a driving unit according to the first embodiment of the disclosure.

The dust removal apparatus 1 includes an exhaust unit 100, a filter 200, and a dust removal unit 300.

The exhaust unit 100 discharges dust and moisture from a melting space (T) of a melting furnace to the outside, and includes an exhaust port 110, a first pipe 120, a second pipe 130, a connection unit 140, a moisture cooler 150, a pressure gauge 160, and a stopper 170.

The exhaust port 110 communicates with the melting space (T), and is formed as a hole through which dust and moisture generated in the melting space (T) are emitted to the outside. According to the disclosure, the exhaust port 110 is located on the top of the melting furnace, but is not limited thereto.

The first pipe 120 is connected to the exhaust port 110 in a first direction, and adjustable in volume and length so that dust and moisture emitted from the exhaust port 110 can move slowly through the first pipe 120.

Here, the first direction refers to the vertical direction, and the vertical direction may be angled at 80 degrees to 105 degrees, 85 degrees to 100 degrees, and 85 degrees to 95 degrees, and preferably 87.5 degrees to 92.5 degrees.

The second pipe 130 is connected to and bent from the first pipe 120. According to the disclosure, the moisture cooler 150 surrounds the second pipe 130 so that moisture passing through the second pipe 130 can be cooled, but is not limited thereto.

Here, the horizontal direction may be angled at 0 degrees to 15 degrees and 0 degrees to 10 degrees, and preferably 0 degrees to 5 degrees.

The connection unit 140 connects the first pipe 120 and the second pipe 130 to each other. According to the disclosure, the first pipe 120 and the second pipe 130 are connected to each other through the connection unit 140 bent having an “L” shape, but is not limited thereto.

The moisture cooler 150 has a larger diameter than the second pipe 130, and surrounds the second pipe 130 with the maximum area to maximize the cooling efficiency of cooling the moisture discharged through the second pipe 130.

The pressure gauge 160 measures the internal pressure of the first pipe 120 and the internal pressure of the second pipe 130. According to the disclosure, the pressure gauge 160 measures the pressure of the first pipe 120 and the pressure of the second pipe 130 at the same time. Although not shown, a monitoring system and a communication system may be added to check change in those pressures in real time.

The stopper 170 is installed (attached) to the inner wall of the connection unit 140 to prevent the filter 200 from being separated. According to the disclosure, two stoppers 170 are installed (attached) in the horizontal direction of the second pipe 130 to limit the movement of the filter 200, but are not limited thereto. According to an alternative embodiment, the number and shape of the stopper 170 may be varied depending on the shape of the connection unit 140 and the installation location of the filter 20.

The filter 200 is located inside the exhaust unit 100, and is arranged to have one side facing the melting space. The filter 200 is shaped like a plate and is diagonally located in the connection unit 140 between the first pipe 120 and the second pipe 130.

Referring to FIGS. 3A and 3B, according to the disclosure, the filter 200 is either a mesh type (see FIG. 3A) or a perforated type (see FIG. 3B), but is not limited thereto. Although not shown, a separate support unit may be further provided inside the connection unit 140 so as to secure the filter 200.

The dust removal unit 300 improves the dust removal capability of the filter 200 or improves the performance of the filter 200, and includes the driving unit 310 and the driving control unit 320.

The improvement in the dust removal capability of the filter 200 or the performance of the filter 200 by the dust removal unit 300 means that physical force is applied to the filter 200 through the operation of the dust removal unit 300 and thus the dust accumulated in the exhaust port 110 is removed more or more easily by the filter 20.

Further, the improvement in the dust removal capability means that the dust removal effect by the filter 200 is maximized, which means that the performance of the filter 200 itself is maintained constant and the dust removal occurs consistently in the filter 200.

The easier the dust desorption occurs in the filter 200, the higher the dust removal capability or performance of the filter 200 is improved through the dust removal unit 300.

The driving unit 310, 310′, 310″ or 310′″ applies physical force to the filter 200 to desorb dust accumulated in the filter 200.

The driving control unit 320 controls the operation of the driving unit 310, 310′, 310″ or 310′″ based on the measured value of the pressure gauge 160, so that the dust accumulated in the filter 200 can be desorbed only when a pressure difference between the first pipe 120 and the second pipe 130 is above a certain level.

Specific dust desorption using the dust removal unit 300 is as follows. First, the internal pressure of the first pipe 120 and the internal pressure of the second pipe 130 are checked through the pressure gauge 160, thereby measuring change in pressure before and after the filter 200.

The pressure increases when a lot of dust is accumulated in the filter 200. In this case, the driving control unit 320 controls the operation of the driving unit 310 to apply physical force to the filter 200, thereby desorbing the dust accumulated in the filter 200. Then, the desorbed dust is resupplied to the melting space (T).

The driving unit 310 according to the first embodiment operates under the control of the driving control unit 320, and may further include a separate support unit (not shown) to be secured to the driving unit 310. Further, a separate power device may further be included to supply power to the driving unit 310.

Referring to FIG. 4, the driving unit 310 according to the first embodiment of the disclosure is partially coupled to the filter 200, and operates to move a portion of the filter 200 up and down. As the filter 200 moves up and down, the accumulated dust is desorbed and resupplied to the melting space (T) by its own weight.

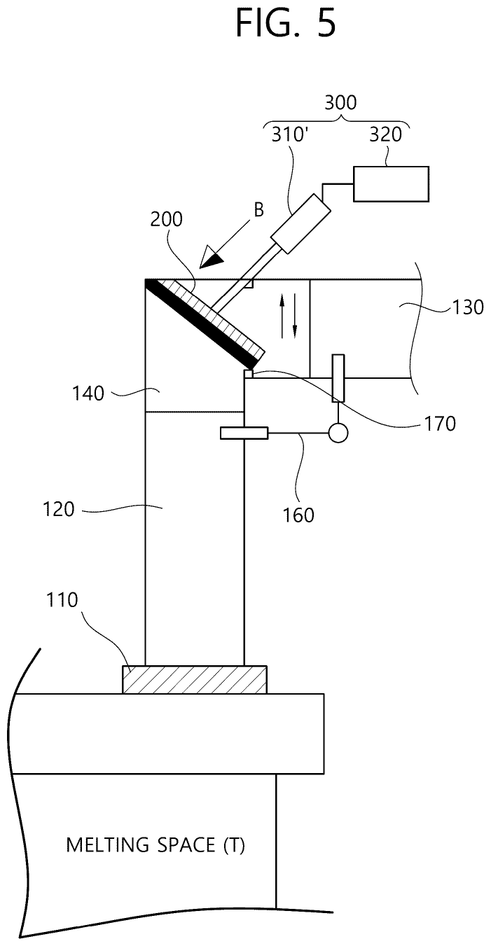

The driving units according to second to fourth embodiments will be described with reference to FIGS. 5 to 9.

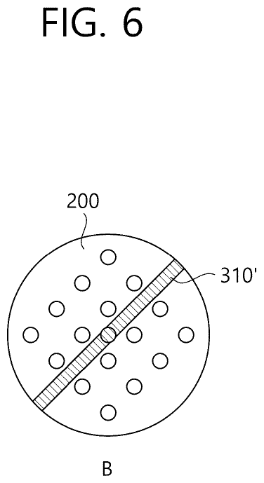

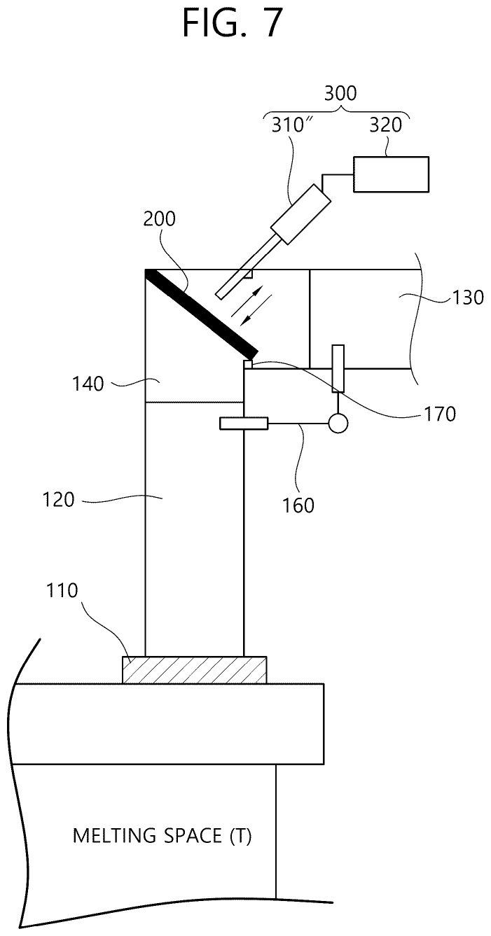

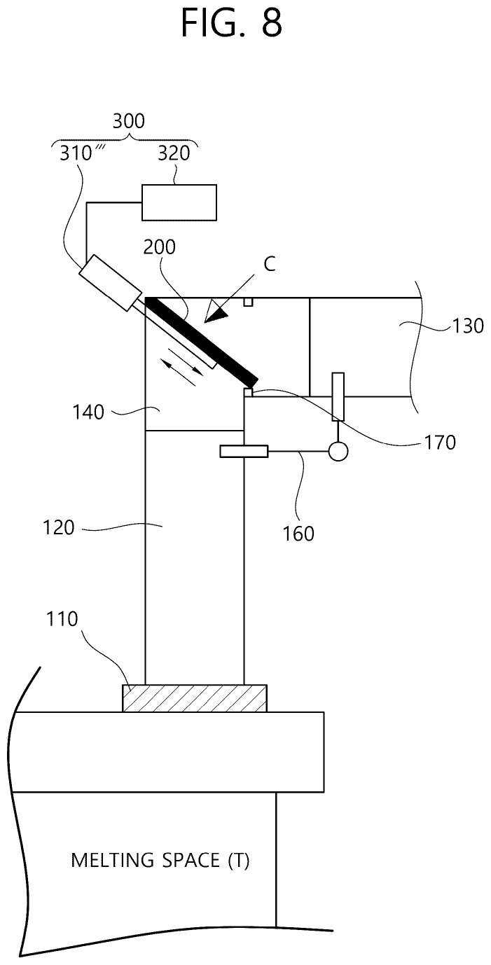

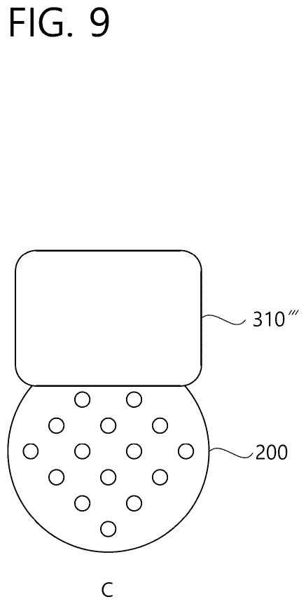

FIG. 5 illustrates a driving unit according to the second embodiment of the disclosure, FIG. 6 shows “B” in FIG. 5, FIG. 7 illustrates a driving unit according to the third embodiment of the disclosure, FIG. 8 illustrates a driving unit according to the fourth embodiment of the disclosure, and FIG. 9 shows “C” in FIG. 8

Referring to FIGS. 5 and 6, the driving unit 310′ according to the second embodiment of the disclosure includes a propeller that applies air flow to the filter 200. The propeller desorbs dust accumulated in the filter 200 by rotating force, and the dust desorbed in this case is resupplied to the melting space (T) by its own weight.

Referring to FIG. 7, the driving unit 310′″ according to the third embodiment of the disclosure includes a hammer that applies physical impact to the filter 200. By the hammering of the hammer, the filter 200 vibrates, and the dust accumulated in the filter 200 is desorbed by the vibration. Then, the desorbed dust is resupplied to the melting space (T) by its own weight.

According to the third embodiment, the hammer being not in contact with the filter 200 comes into contact with a portion of the filter 200 by the hammer ring based on the up and down movement, thereby causing the filter 200 to vibrate. According to an alternative embodiment, the dust accumulated on the filter 200 may be desorbed by the vibration of the hammer in the state that the hammer is being in contact with the filter 200.

Referring to FIGS. 8 and 9, the driving unit 310′″ according to the fourth embodiment of the disclosure is operated under the control of the driving control unit 320, and includes a sliding member that slides along a surface being in contact with the filter 200 to desorb the dust accumulated in filter 200. Then, the desorbed dust is resupplied to the melting space (T) by its own weight.

According to the disclosure, it is possible to prevent dust from accumulating inside the pipe cooler due to the dust generated when solid waste is input to the melting furnace and a large amount of moisture generated when liquid waste is input to the melting furnace.

Further, the amount of dust discharged through the exhaust system is reduced, thereby preventing difficulty in handling due to the scattering of dust and increase in costs for the dust treatment, and consequentially having an effect on increasing the utilization rate of the melting furnace.

The aforementioned embodiments are merely examples for describing the disclosure, and the disclosure is not limited thereto. Various modifications from these embodiments can be made by a person, who has ordinary knowledge in the art to which the disclosure pertains, to implement the disclosure, and thus the technical scope of the disclosure should be defined by the appended claims.

1. An apparatus for removing dust emitted from a melting furnace, comprising:
an exhaust unit that discharges dust and moisture from a melting space of the melting furnace to an outside;
a filter that is located inside the exhaust unit, and arranged to have one side facing the melting space; and
a dust removal unit that improves the filter in dust removal capability.

2. The apparatus of claim 1, wherein the exhaust unit comprises:
an exhaust port communicating with the melting space;
a first pipe connected to the exhaust port in a first direction;
a second pipe connected to and bent from the first pipe;
a connection unit connecting the first pipe and the second pipe; and
a moisture cooler cooling the moisture discharged through the second pipe.

3. The apparatus of claim 2, wherein the exhaust unit comprises:
a pressure gauge measuring each internal pressure of the first pipe and the second pipe; and
a stopper for preventing the filter from separation,
the first direction comprises a vertical direction, and
the second pipe extends in a horizontal direction.

4. The apparatus of claim 2, wherein
the filter is shaped like a plate and diagonally located in the connection unit,
the filter is at least one of a mesh type and a perforated type, and
the dust is desorbed from the filter through the dust removal unit, and the desorbed dust is resupplied to the melting space.

5. The apparatus of claim 2, wherein
the dust removal unit comprises:
a driving unit applying physical force to the filter to desorb accumulated dust; and
a driving control unit controlling operations of the driving unit based on a measured value of the pressure gauge, and
the driving control unit controls the driving unit to operate only when a pressure difference between the first pipe and the second pipe is above a certain level.

6. The apparatus of claim 5, wherein the driving unit operates to move a portion of the filter up and down.

7. The apparatus of claim 5, wherein the driving unit comprises a propeller that applies air flow to the filter.

8. The apparatus of claim 5, wherein the driving unit comprises a hammer that applies physical impact to the filter.

9. The apparatus of claim 5, wherein the driving unit comprises a sliding member that slides along a surface being in contact with the filter.
